(19) United States
(12) Patent Application Publication
(10) Pub. No.: US 2023/0207972 A1
(43) Pub. Date: Jun. 29, 2023

(54) ELECTRONIC COMPONENT FOR A CELL-CONTACTING SYSTEM AND METHODS FOR PRODUCING A CELL-CONTACTING SYSTEM AND A BATTERY MODULE

(71) Applicant: Diehl Advanced Mobility GmbH, Zehdenick (DE)

(72) Inventors: Jürgen Weyh, Viernau (DE); Martin Wieberger, Berlin (DE); Ingo Weber, Potsdam (DE); Dario Kremser, Schönfliess (DE)

(21) Appl. No.: 18/173,119

(22) Filed: Feb. 23, 2023

Related U.S. Application Data
(63) Continuation of application No. PCT/EP2021/071234, filed on Jul. 29, 2021.

(30) Foreign Application Priority Data
Aug. 27, 2020 (DE) 10 2020 005 239.8

(51) Int. Cl. H01M 50/519; H01M 50/503; H01M 50/516; H01R 12/55

(52) U.S. Cl. CPC H01M 50/519; H01M 50/503; H01M 50/516; H01R 12/55; H01R 12/53

(57) ABSTRACT

An electronics component for a cell-contacting system with cell connectors for a battery contains a printed circuit board of a measuring and/or management arrangement for the battery with a communication interface. The printed circuit board can be electrically connected to precisely two of the cell connectors and, for this purpose, has at least one soldering area for each of the cell connectors. At least one electrical connecting element is provided which is areally of strip-like form and can be soldered onto the soldering areas. Wherein a first connecting element for mechanical fastening and/or thermal transfer being of comparatively mechanically rigid and comparatively short design, and a second connecting element for thermal and/or mechanical length compensation being of comparatively mechanically flexible and long design, are provided. A cell-contacting system with cell connectors contains at least one electronics component.

### CROSS-REFERENCE TO RELATED APPLICATION

This application is a continuation, under 35 U.S.C. § 120, of copending International Patent Application PCT/EP2021/071234, filed Jul. 29, 2021, which designated the United States; this application also claims the priority, under 35 U.S.C. § 119, of German Patent Application DE 10 2020 005 239.8, filed Aug. 27, 2020; the prior applications are herewith incorporated by reference in their entirety.

### FIELD AND BACKGROUND OF THE INVENTION

The invention relates to cell-contacting systems for electrical energy-storage devices, in this case in particular batteries, in particular traction batteries for electrically driven motor vehicles.

Electrical energy-storage devices are used for the storage or temporary storage of electrical energy. Such energy-storage devices can comprise, for example, accumulator or battery packs with a plurality of cells, i.e. battery or accumulator cells. Such energy-storage devices are referred to within the sense of the present patent application for the sake of simplicity generally as “batteries”. Such batteries find application in particular as traction or driving batteries for electric motor vehicles.

Cell-contacting systems are connecting systems which serve to electrically connect individual cells of the battery, in particular accumulator or battery cells or batteries consisting of a plurality of cells, to one another. The individual cells or groups of cells are interconnected by corresponding cell-contacting systems such that a desired target voltage is made available at connectors or tapping points of the cell-contacting systems.

The cell-contacting systems here generally also contain means for monitoring both the individual cells and the whole battery, for example in terms of temperatures, voltages, and currents and for managing them in charging or discharging mode. Such means are in particular sensor lines, sensors, or alternatively electronic switches.

For example, a connecting system for an energy-storage device is known from European patent EP 2 639 857 B1 (corresponding to U.S. patent publication No. 2013/0244499). The energy-storage device has a plurality of cells, with a plurality of cell connectors, retained by a support system, for electrically interconnecting the cells, with a storage control unit for monitoring an energy reserve and/or charging state of the cells. The support system is configured to accommodate and/or retain the storage control unit, and wherein the storage control unit is configured so that it is integrated with the support system or can be detached therefrom. A support part comprised by the support system has an interface and/or receptacle for the storage control unit.

### SUMMARY OF THE INVENTION

The object of the present invention is to propose improvements with respect to a cell-contacting system.

The object is achieved by an electronic component according to the independent cell-contacting system patent claim for a cell-contacting system. Preferred or advantageous embodiments of the invention and other categories of the invention can be found in the further claims, the following description, and the attached figures.

The cell-contacting system is in particular one suitable for a traction battery of an electrically driven motor vehicle.

The invention is based on the fact that the cell-contacting system has a plurality of cell connectors which serve for power contacting battery cells of a battery. This means that the battery power is removed from the latter or fed into it via the cell connectors. In particular, the electronic component is configured with regard to a cell-contacting system for the intended purpose. “For the intended purpose” means that the electronic component is structurally compatible with a specific or a specific type of cell-contacting system or battery and is provided for use there; for example, is configured for the geometrical requirements, power requirements, etc.

Within the sense of the abovementioned suitability for the intended purpose, within the application properties of cell-contacting systems and batteries are therefore also described although, strictly speaking, the actual components are not part of but are the subject of the respective invention. However, these statements also apply, mutatis mutandis, for the cell-contacting systems and batteries described below and may not be explicitly repeated again there.

In particular, a (at least later, in the mounted state) fixed and known geometrical relative position of the cell connectors relative to one another or in the cell-contacting system is therefore also known, at least when the cell-contacting system is connected as intended to the battery.

The electronic component contains a printed circuit board of a measuring and/or management arrangement for the battery, wherein the printed circuit board (and its lines/components) can be connected electrically to precisely two of the cell connectors. For this purpose, i.e. for connection to the cell connector, the printed circuit board has at least one soldering surface for each of the cell connectors. The cell connector is to be soldered to this soldering surface so that the electrical connection is established. The printed circuit board can here in particular also be configured with multiple parts.

The electronic component contains for each of the cell connectors at least one electrical connecting element which can be soldered to at least one of the soldering surfaces. Each of the connecting elements serves for the respective electrical connection of the soldering surface and hence the printed circuit board to the cell connector. At least one of the cell connectors is in particular unipolar.

At least one of the connecting elements, in particular all of the first and/or second ones (see below), have a flat strip-like configured. “Flat strip-like” means that they have an in particular uniform height in relation to their lateral and longitudinal extent. “Strip-like” can here include straight, bent, arched, angled, curved configurations, in each case viewed in the direction of the longitudinal extent of the strip. Put differently, the connecting element with a flat strip-like design runs within a plane.

At least a first one of the connecting elements leads to a first one of the cell connectors. It (the first one) serves for the mechanical fastening and/or heat transmission between cell connectors and the printed circuit board and is configured so that it is relatively (i.e. in relation to the second one, see below) mechanically rigid and relatively short. The configuration serves to ensure and promote the desired properties (fastening, transmission, in particular physical bridges, thermal bridges).

At least a second one of the connecting elements leads to the second one of the cell connectors. It (the second one) serves for thermal and/or mechanical (3D) length compensation between the cell connectors and/or a corresponding compensation between the second cell connector and the printed circuit board and is configured so that it is relatively (in relation to the first one) mechanically flexible or more flexible and relatively long or longer (again, viewed in the longitudinal direction of the strip). Here too, the configuration serves to ensure and promote the desired properties (3D length compensation or resiliency, in particular strain relief).

The, in particular 3D, “length compensation” should here be understood within the sense of 3D resiliency or 3D movability. It is to be understood such that the connecting element can compensate movements, displacements of its ends or fixing points in all three spatial directions, i.e. in 3D, or be resilient in response to them. This is achieved in particular by a curving or bridge-like or U-shaped or S-shaped profile of the connecting element. The same also applies for the shape of the wire mentioned below.

The printed circuit board moreover has at least one communications interface for the data exchange of information with a remote station. Information is any information that is useful or necessary for battery management, in particular on currents, voltages, and temperatures of the contacted battery in the mounted state of the battery or when it is in operation.

Starting from the printed circuit board, communication can here take place in one or both directions (incoming/outgoing). The remote station can be a communications interface of a different printed circuit board (in particular a different electronic component) or a different remote station inside or outside the cell-contacting system, for example an external evaluation unit, central control system, etc.

The electronic component thus has connecting elements for precisely two cell connectors. The electronic component thus serves to evaluate the state of a battery with respect to precisely two of its cell connectors. The voltage of an individual battery cell or its temperature, its impedance, power output, etc can thus be calculated. A series of such electronic components can thus be placed and connected to one another in communicating fashion in an overall battery in order to be able to manage the overall battery.

In particular, measurement signals from the battery (voltages, currents, temperatures, etc) are received or generated on the printed circuit board. In particular, conversion of such measurement signals into a data-transmission signal takes place on the printed circuit board in order to transmit the signal via the communications interface.

According to the invention, a printed circuit board, which performs electrical relaying/processing of measurement signals, is introduced/integrated into the cell-contacting system. The cell-contacting system with the electronic components (printed circuit board, etc) is expanded by the communications interface such that a data-transmission system (wired or wireless) can be used for communication between individual printed circuit boards or cells of a module and between multiple battery modules.

According to the invention, there is a connecting element from the printed circuit board to the cell connectors which is flat and optionally can be configured so that it is corrosion-resistant, fulfills the function of 3D resiliency or strain relief (flexibility) and represents a physical bridge (because it is relatively rigid and short, for example a thermal bridge) between the cell connectors and the printed circuit board, in particular to a sensor location on the printed circuit board as a sensing element. Direct attachment both on the load path (cell connector) and on the printed circuit board (PCB) is ensured by optional partial coating of the base material.

According to the invention, it is possible to carry out mounting of the printed circuit board (PCB/soldering) only once the cell-contacting system (CCS) has been connected to the battery (cell/welding). In particular, an aluminum connecting element is a stamped part and one which serves as a physical bridge. In particular, the aluminum connecting element can be configured such that it is already corrosion-resistant (see below). A selective (for example, in a soldering region) coating (in particular tin coating) of the connecting element (in particular aluminum) enables contacting to the printed circuit board (PCB/FPC flexible printed circuit, soldering of tin-coated aluminum to a soldering surface, in particular copper). It moreover enables a suitable pairing of materials when contacting cell connectors (connecting element as uncoated aluminum on the aluminum of the cell connector).

A sequence during the processing (production of a cell-contacting system/battery module) can favorably be selected for heat inputs (soldering: high/laser welding: low) such that, for example, a previously implemented soldering point does not soften again during subsequent welding.

Connecting elements (in particular the second ones but also wires, for example as a communications medium, see below) allow 3D resiliency or strain relief for thermal movements. In particular the wiring (for example, with a copper enameled wire) as a bus transmission medium enables thermal movements by virtue of 3D resiliency or strain relief. Data transmission in the CCS (cell-contacting system) itself and between the CCS and a remote station/evaluation unit etc can be designed as desired.

According to the invention, an electronic component (printed circuit board with corresponding components) is integrated into the cell-contacting system and converts the measurement signals of the signal lines (connecting elements) into a signal (for example, digital signal) which can be used for data transmission systems (transmission via the communications interface). This results in the possibility of integrating a data transmission system (for example, a wired or wireless BUS) into the CCS.

There is optionally a selective coating in the (in particular soldering) region of the connecting element in order to enable an aluminum/copper connection. This results in the optional possibility of indirect thermal transmission to the printed circuit board by the connecting element without having to place an NTC module (negative temperature coefficient) directly on the cell connector.

The invention is based on the realization that electromechanical line systems are used in the products (cell-contacting systems) currently known from the prior art for relaying signals. The processing of signals is effected externally (i.e. outside the CCS). Sensors are attached directly on the components to be monitored, separate from the processing electronics. Similar (measurement) signals are made by means of FPCs or copper conductors with plug connectors. The control unit/PCB is usually arranged externally.

According to the invention, there is an alternative to the existing solutions known from the prior art for relaying physical status variables from and between battery components to a decentralized signal evaluation system or processing system without cabling the individual components. Separate submodules and sensor systems are functionally integrated.

Electronics are integrated into cell-contacting systems (single-/multi-cell design). Electronics are attached to aluminum sense points (the location of the cell connector at which a measurement is to be made). Cell-contacting systems are expanded by one or more electrically conductive components which enable the relaying and interconnecting of signal and sensor lines inside battery systems for further processing.

In a preferred embodiment of the invention, at least one of the connecting elements has a selective coating in a soldering region to be soldered to the soldering surface. “Selective” means here that the coating is limited to a corresponding region of the connecting element. In particular, this is precisely the soldering region, possibly expanded by a tolerance region/surrounding area of the soldering region which is chosen, for example, such that soldering takes place securely within the region of the coating, including all tolerances. The printed circuit board is thus securely soldered to the connecting element.

In a preferred embodiment, at least one transition region between the base material of the connecting element and the coating is sealed against corrosion. Corrosion protection of the connecting element thus results. The sealing is effected to such an extent and in such a way that, taking all tolerances into account, the connecting element, when soldered to the printed circuit board, is completely and securely protected from corrosion.

In a preferred embodiment, at least one of the connecting elements is made from aluminum (in particular as a base material). Where an abovementioned coating is provided, the coating is alternatively or additionally a tin coating. In particular, aluminum (as an optional base material of the connecting element) coated with tin is soldered particularly well to copper (as an optional material of the soldering surface).

In a preferred embodiment, at least one, preferably all the first and/or second, of the connecting elements is a stamped part from a piece of sheet metal. The piece of sheet metal is in particular a sheet of aluminum. Connecting elements of a uniform thickness which are strip-like and flat (which results in particular automatically in the case of a section of a piece of sheet metal of uniform thickness) can thus be produced particularly well.

In a preferred embodiment, the printed circuit board contains a temperature sensor which is rigidly attached to the printed circuit board. Moreover, the temperature sensor is attached such that it is coupled thermally to the soldering surface for the first connecting element. In particular, the temperature sensor is arranged on the soldering surface such that it is as close, as tight, and as well thermally coupled as possible to the soldering surface, in particular directly adjoining the latter, below the latter, etc. The temperature sensor thus results in a sensor location on the printed circuit board which is optimally thermally coupled to the cell connector via the soldering surface and the mounted connecting element without the need to have to place a temperature sensor directly on the cell connector, externally to the printed circuit board.

In a preferred embodiment, at least one of the first connecting elements has a rectangular shape. Such a shape can be produced particularly simply as a flat strip or tongue, in particular as a stamped part.

In a preferred embodiment, at least one of the second connecting elements is configured with an S-shape (again within the plane or along its flat strip-like extent). In other words, it is a strip or band running in an S-shape. The connecting element has a straight central limb. A sub-limb adjoins each end of the central limb with a 180° turn. The two sub-limbs therefore run parallel to the central limb, one on one side of the central limb and the other on the other side. Adjoining the ends still further from the central limb are respective lead-in limbs, which branch off perpendicularly, i.e. with a 90° turn, from the sub-limbs, i.e. run away from the latter at right angles to the central limb and the part limbs. The sub-limbs have only a partial length, in particular half the length of the central limb. The corresponding connecting element is in particular generated by straight longitudinal sections separating the sub-limbs from the central limb which end in particular in round free cuts for strain relief. In particular, correspondingly round free cuts are also provided at the branching points of the lead-in limbs from the sub-limbs. The corresponding connecting element can be made particularly simply as a stamped part from a piece of sheet metal.

In a preferred embodiment, the communications interface has at least one holding means for a wire as at least part of a communications channel or as a transmission medium for the communication. The communications channel is formed in particular from two, three, or four wires. The holding means is in particular a tuning fork contact. The wire or connecting wire is configured in particular as a copper enameled wire. The holding means and the wire together form a wire section. The wire section contains the holding means, in particular at least one clamping fork for a connecting wire, and the connecting wire leading from the clamping fork to the remote station. The connecting wire is in particular an enameled wire, in particular a copper enameled wire. By virtue of the wiring layout, it is especially possible to easily make adaptations to mounting circumstances. The wire is per se sufficiently flexible to ensure thermal or mechanical (vibrations, movements) (3D) length compensation, as explained above, between the communications interface and the remote station.

In an alternative embodiment, the communication is via radio.

In a preferred embodiment, at least one of the connecting elements is a one-piece direct connector between the printed circuit board and the cell connector. In particular, the abovementioned stamped parts can be produced as a single piece particularly easily.

In a preferred embodiment, in a mounted state in the cell-contacting system, the printed circuit board is fastened mechanically to the cell connectors and consequently in the cell-contacting system only by means of the connecting elements. The printed circuit board then does not need to be mechanically retained separately. In particular, this results in dual functionality for the first connecting element as a thermal bridge and a mechanical fastening element, and possibly also for the second connecting element as thermal/mechanical (3D) length compensation and a fastening element.

The object of the invention is also achieved by a cell-contacting system according to the independent cell-contacting system patent claim. The cell-contacting system and at least some of its embodiments and the respective advantages have analogously already been explained in connection with the electronic component according to the invention.

The cell-contacting system contains a plurality of cell connectors which serve for the power contacting of battery cells, and at least one electronic component according to the invention. In a corresponding cell-contacting system, the number, position, form, geometry, relative position to one another, etc of cell connectors and other structural parts are known. In particular, it is thus possible to adapt an electronic component to a specific cell-contacting system and not just one for the intended purpose. In particular, given a number n of cell connectors, n−1 electronic components are provided which always connect two of the n cell connectors to each other such that, for example, all the partial voltages between all the cell connectors can be calculated.

The object of the invention is also achieved by a method according to the independent method patent claim for producing a cell-contacting system according to the invention. In the method, the electronic component or components according to the invention is or are supplied in the unmounted state, i.e, as individual parts in terms of the printed circuit board and the connecting elements. First, the electrical connecting elements are then connected to the printed circuit board by soldering. Next, the electrical connecting elements are connected to the cell connectors, in particular by welding. As explained above, because a low amount of heat is applied during the subsequent welding, there is no softening of the soldering points which have already been completed beforehand.

The object of the invention is also achieved by a method according to independent method patent claim for producing a battery module. The battery module contains a battery and a cell-contacting system according to the invention contacting the battery. In the method, the electronic component or components according to the invention is or are supplied, as above, as individual parts. The remaining cell-contacting system or systems according to the invention (without electronic components) are supplied separately therefrom. First, the cell-contacting system without the electronic components is connected to the battery. Next, the printed circuit boards are electrically connected to the cell connectors by means of the connecting elements, in particular according to the method according to the invention as was explained above.

The invention is based on the following insights, observations, and considerations and also has the following embodiments. The embodiments are here also referred to, in a partly simplified fashion, as “the invention”. The embodiments can here also contain parts or combinations of the abovementioned embodiments or correspond to them and/or possibly also include embodiments not already mentioned.

According to the invention, aluminum stamped parts are possible as connecting elements and the stamped parts can be attached in a stamped band. Selective coating of the connecting element with tin is possible, as is selective coverage of the coating transition for the purpose of corrosion protection. Length and vibration compensation is integrated via the shape given to the connecting elements, in particular via its stamping geometry. Attachment (printed circuit board to cell connectors/connecting element) via a soldering process to a PCB, flex PCB, or rigid-flex PCB is possible. Automatic processing on assembly machines is possible. The invention is used to attach a CCS control electronics system to the cell connectors. A temperature signal is transmitted in particular by virtue of a suitable design of the first connecting element, in particular as an aluminum stamped part. A laser-welded connection is possible by using aluminum material for the connecting element. This means that the material of the connecting element is the same as the cell connectors (usually also made from aluminum) in the CCS.

An aluminum stamped part is in particular a connecting element of the PCB to the sensing point (desired measuring point for voltage, temperature, current, etc) on the cell connector. Selective coating with tin on the connecting element makes it possible for the base material of the connecting element to be the same in the case of laser welding to the cell connector. Corrosion protection can already be applied to the individual part (connecting element/printed circuit board with a connecting element). It is possible to create a bus system inside the CCS module by means of a copper enameled wire. As well as the transmission of voltage/current and corresponding measured variables, the connecting element (stamped part) can also transmit the temperature to the printed circuit board.

Other features which are considered as characteristic for the invention are set forth in the appended claims.

Although the invention is illustrated and described herein as embodied in a electronic component for a cell-contacting system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of an electronic component according to the invention; and

FIG. 2 is a plan view of a cell-contacting system with four electronic components according to FIG. 1.

### DETAILED DESCRIPTION OF THE INVENTION

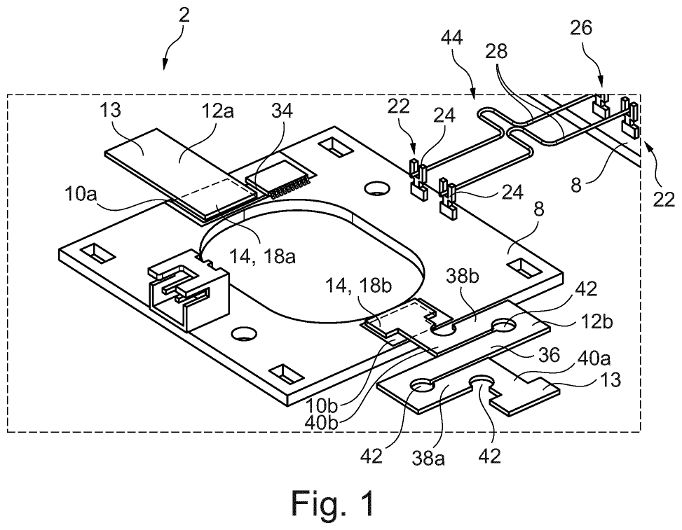

Referring now to the figures of the drawings in detail and first, particularly to FIG. 1 thereof, there is shown an electronic component 2 for a cell-contacting system 4.

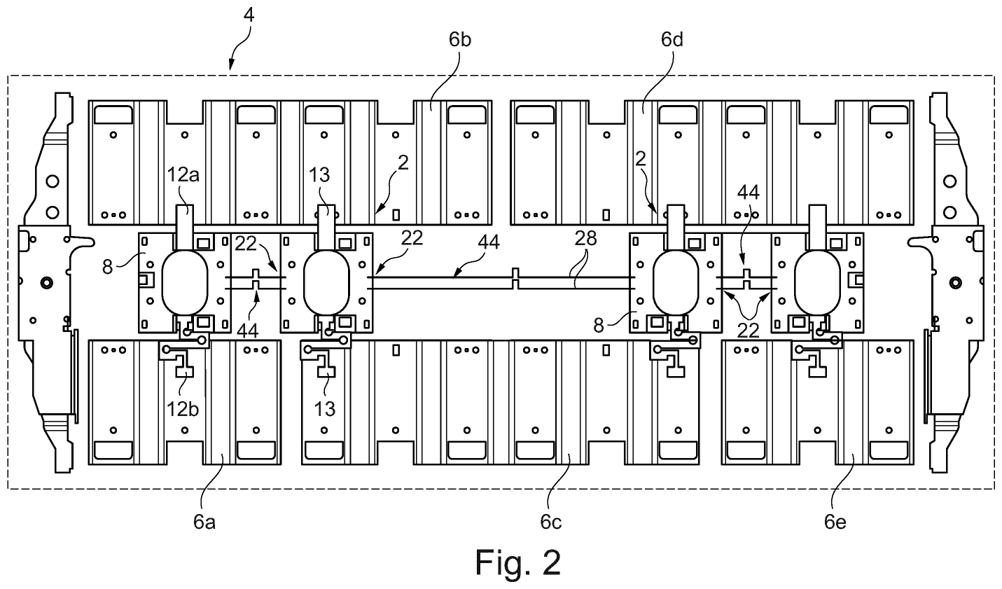

FIG. 2 shows four (n−1, see below) of the electronic components 2 from FIG. 1 in their mounted state in the cell-contacting system 4. The cell-contacting system 4 contains a plurality n of cell connectors 6, in this case five. The cell connectors 6a-e serve for power contacting battery cells (not illustrated in the figures) of a battery. In the final mounting process (not illustrated) of a battery system, the cell-contacting system 4 is mounted on the battery by, inter alia, the cell connectors 6a-i being welded to the battery poles.

The electronic component 2 contains a printed circuit board 8. This is part of a management arrangement (not illustrated in detail in the figures) for implementing battery management at the battery whilst it is operating. The printed circuit board 8 contains in the example two soldering surfaces 10a,b, in this case in the form of copper (Cu) surfaces. The soldering surfaces 10a,b serve to electrically connect the printed circuit boards 8 to the cell connectors 6a-e via in this case two respective connecting elements 12a,b. The two connecting elements 12a,b are also part of the respective electronic component 2.

Each of the connecting elements 12a,b here has a single-pole configuration and, at its respective end facing the printed circuit board 8 in the mounted state, a soldering region 18a,b which is only indicated in dashed lines and cannot be seen because it is situated on the underside, pointing downward in the illustration, of the connecting elements 12a,b and is already soldered to the soldering surfaces 10a,b.

The connecting elements 12a,b are configured as flat, namely as aluminum pieces of sheet metal which are relatively thin relative to their flat transverse extent and are configured as strips. The connecting elements 12a are straight rectangular strips and the connecting elements 12b are strips which run with an S-shape and have a respective widened portion at their ends.

The connecting elements 12a to each of the first cell connectors (6b,d) are configured so that they are mechanically relatively rigid (compared with the connecting elements 12b) and relatively short for mechanical fastening and thermal transfer between the cell connectors 6b,d and the printed circuit board 8.

The connecting elements 12b to each of the second cell connectors (6a,c,e) are configured so that they are mechanically relatively flexible (compared with the connecting elements 12a) and long for thermal and/or mechanical 3D length compensation between the cell connectors 6a-e and/or between the second cell connector (6a,c,e) and the printed circuit board 8. In the example, this is achieved by the length being increased by the S-shaped profile of the strip, i.e. with two 90° changes in direction and two 180° changes in direction. Thus, a straight central limb 36, adjoining with a 180° change in direction on both sides a half-length sub-limb 38a,b parallel thereto, and a lead-in limb 40a,b, branching off from the sub-limb at right angles (with a 90° change in direction) on both sides, are provided.

The flexibility of the structure is achieved by the length of the strip and the bendability of the structure at the respective four angles/changes in direction which, inter alia, are moreover provided with round free cuts 42.

In the example, the printed circuit board 8 moreover has a communications interface 22 which is also part of the electronic component 2. Each of the communications interfaces 22 is here configured in the form of two holding means 24, joined to the printed circuit board 8, for wire 28 in the form of tuning fork contacts. The tuning fork contacts are joined to the printed circuit board or mechanically rigidly connected thereto. Each of the holding means 24 serves to hold a wire 28, in this case a copper enameled wire, so that it is electrically contacted and mechanically fastened. Communication then takes place via the corresponding wires 28 as a communications line/communications medium or bus system 44 for data exchange with a remote station 26, in this case a communications interface 22 of a further printed circuit board 8. The wires 28 thus form a communications channel 30 of the bus system 44.

In the example, the connecting elements 12a,b are one-piece direct connectors between the printed circuit board 8 and the respective cell connector 6a-e.

In the example, the printed circuit board 8 is retained mechanically in the cell-contacting system 4 only via the connecting elements 12a-e and only on the cell connectors 6a-i.

In the exemplary embodiment, the printed circuit board 8 is configured as a single-cell chip PCB, i.e. it is designed for precisely two cell connectors (FIG. 2: 6a,b/6b,c/6c,d/6d,e), and can thus detect their two, possibly different potentials or other parameters. For a battery system with, for example, n=five cell connectors, thus only n−1=four electronic components 2 with such printed circuit boards 8 are required.

In the final mounted state (not illustrated), the CCS 4 is mounted on the battery. The signal lines (in this case implemented by the connecting elements 12a,b) of the individual potential level (for example, potentials of the contacted cell connectors 6a-e) of the battery system are then combined on the individual printed circuit boards 8 as a processing system (in this case a PCB, alternatively also a flex/rigid-flex PCB). The potential levels, converted into a digital signal, are relayed there, in this case to the remote station 26, by means of the communications interfaces 22 via a data transmission system (BUS, bus system 44, in this case the wires 28). The electronic components required for this are situated on the printed circuit board 8.

A single-cell chip printed circuit board 8 taps the signals between two successive potentials (cell connectors 6a,b/6b,c/6c,d/6d,e) and for this purpose is located between in each case two cell connectors 6. Two successive potentials are routed to the next potential via selectively coated connecting elements 12a,b (12b with 3D resiliency or strain relief) which are configured as long. The coating 14 which is selective (because it is not applied over the whole of the connecting elements 12) is situated on the connecting element 12a,b (selectively only) in the respective soldering region 18a,b and is also not visible in the figures and is indicated only by dashed lines.

Impedance can be measured because the connecting elements 12a,b can be reproduced with a high degree of accuracy. The connecting elements 12a,b can be or are configured here as stamped parts and can be situated on a stamped band and automatic fitting is thus possible (not illustrated). The selective coating 14 simplifies the welding of the connecting elements 12 at the locations 13 to the cell connectors 6 because the material is the same (uncoated aluminum of the connecting element 12 and aluminum of the cell connector 6) and also fulfills the claimed corrosion protection. The expansion in length due to heat and the vibration compensation are achieved by the stamping geometry of the connecting elements 12b. The attachment to the printed circuit board 8 is effected by a soldering process, wherein the PCBs can consequently be configured as rigid, flex, or rigid-flex PCBs. The soldering takes place between the soldering surface 10 and the soldering region 18.

The data transmission is effected by special copper pins (tuning fork contacts, holding means 24) which serve for the application of a laser welding process for producing a standard aluminum/copper welded connection. These pins enable the transmission of digital signals between individual printed circuit boards 8 or between individual battery systems.

A plurality of (single-cell chip) printed circuit boards 8 are provided which are each located between two successive potentials (see FIG. 2).

Data transmission is effected by the communications interfaces 22 via BUS links.

The welding between the connecting elements 12 and the cell connectors 6 takes place in each case at the location 13 of the connecting elements 12.

The electronic component 2 is configured as a “single-cell chip” variant (contacts only two cell connectors 6 in each case) and rests on one of the cell connectors 6b,d via the connecting elements 12a in each case mechanically rigidly and sufficiently well coupled thermally and taps the temperature of the cell connector 6b,d via an integrated temperature sensor 34 (NTC, part of the chip illustrated, indicated only symbolically). Two successive potentials (of second cell connectors 6a,c to 6b, 6c,e to 6d) are routed via connecting elements 12b (configured as long and flexible with 3D resiliency and strain relief) to the next potential (cell connectors 6b,d). It is thus also possible to measure the impedance.

The temperature sensor 34 is attached directly to the soldering surface 10a such that it is also located as closely as possible to the connecting element 12a in the mounted state. It is thus optimally thermally linked to the temperature transmission from the cell connector 6 via the connecting element 12a to the soldering surface 10a.

According to FIG. 2, there is a single-cell control system for a cell-contacting system 4 completed correspondingly by a battery (not illustrated): an electrical connection (link/control link logic) is effected by a bus system 44 (connection to the communications interface 22) to the respective next single-cell chip (printed circuit board 8) via in this case a copper enameled wire (welding forks, holding means 24, etc), in the example a two-core bus or a bus system 44 consisting of two wires 28.

The cell-contacting system 4 is produced as follows: first, the electrical connecting elements 12a,b are connected to the printed circuit board 8 by soldering (soldering surfaces 10 and soldering regions 18). Next, the electrical connecting elements 12a,b are connected, in this case welded, to the cell connectors 6.

A battery module which contains a battery and a cell-contacting system 4 contacting the battery is produced as follows: the electronic component 2 and, separately therefrom, the remainder of the cell-contacting system 4 are supplied. First, the cell-contacting system 4 is connected to the battery without the electronic component, i.e. the cell connectors 6 are welded to the battery poles. Next, the printed circuit board 8 is electrically connected to the cell connectors 6 by means of the connecting elements 12, in particular in accordance with the abovementioned method, i.e. the cell-contacting system is produced and completed.

When reading the claim language, the following definitions apply. When the claim language recites A and/or B it means A alone, B alone or A and B. When the claim language recites at least one of A and B it means A alone, B alone or A and B. When the claim language recites at least one of A or B it means A alone, B alone or A and B.

The following is a summary list of reference numerals and the corresponding structure used in the above description of the invention.

### LIST OF REFERENCE SIGNS

2 electronic component
4 cell-contacting system
6a-e cell connector
8 printed circuit board
10a,b soldering surface
12a,b connecting element
13 location
14 coating
18a,b soldering region
22 communications interface
24 holding means
26 remote station
28 wire
30 communications channel
34 temperature sensor
36 central limb
38a,b sub-limb
40a,b lead-in limb
42 free cut
44 bus system

1. An electronic component for a cell-contacting system, the cell-contacting system having a plurality of cell connectors which serve for a power contacting of battery cells of a battery, the electronic component comprising:
a printed circuit board of a measuring and/or management configuration for the battery, said printed circuit board being connected electrically to precisely two of the cell connectors and for this purpose has at least one soldering surface for each of the cell connectors;
a plurality of electrical connecting elements, at least one of said electrical connecting elements being soldered to said at least one soldering surface for each of the cell connectors for a respective electrical connection of said at least one soldering surface to a cell connector of the cell connectors, at least one of said electrical connecting elements configured as a flat strip;
at least a first one of said electrical connecting elements provided for connecting to a first one of the cell connectors for a mechanical fastening and/or thermal transmission between the first cell connector and said printed circuit board is configured so that said first electrical connecting element is relatively mechanically rigid and relatively short;
at least a second one of said electrical connecting elements provided for connecting to a second one of the cell connectors for thermal and/or mechanical length compensation between the cell connectors and/or between the second cell connector and said printed circuit board is configured so that said second electrical connecting element is relatively mechanically flexible or more flexible and long than said first electrical connecting element; and
said printed circuit board has at least one communications interface for a data exchange of information with a remote station.

2. The electronic component according to claim 1, wherein at least one of said electrical connecting elements has a selective coating in a soldering region to be soldered to said at least one soldering surface.

3. The electronic component according to claim 2, wherein:
said electrical connecting elements are formed of a base material; and
at least one transition region between said base material of one of said electrical connecting elements and said selective coating is sealed against corrosion.

4. The electronic component according to claim 1, wherein at least one of said electrical connecting elements:
is made from aluminum; and/or
has a tin coating.

5. The electronic component according to claim 1, wherein at least one of said electrical connecting elements is a stamped part from a piece of sheet metal.

6. The electronic component according to claim 1, further comprising a temperature sensor being rigidly attached to said printed circuit board, said temperature sensor being coupled thermally to said at least one soldering surface for said first electrical connecting element.

7. The electronic component according to claim 1, wherein at least said first electrical connecting element has a rectangular shape.

8. The electronic component according to claim 1, wherein said second electrical connecting element is configured S-shaped with a straight central limb, and adjoining said straight central limb on both sides in each case one sub-limb parallel thereto, and in each case one right-angled lead-in limb branching off from said sub-limb on both sides.

9. The electronic component according to claim 1, further comprising a communications interface which has at least one holding means for a wire as at least part of a communications channel.

10. The electronic component according to claim 1, wherein at least one of said electrical connecting elements is a one-piece direct connector between said printed circuit board and the cell connectors.

11. The electronic component according to claim 1, wherein in a mounted state in the cell-contacting system, said printed circuit board is fastened mechanically to the cell connectors and consequently in the cell-contacting system only by means of said electrical connecting elements.

12. A cell-contacting system, comprising:
a plurality of cell connectors which serve for power contacting battery cells; and
at least one electronic component according to claim 1.

13. A method for producing a cell-contacting system, which comprises the steps of:
providing a plurality of cell connectors which serve for power contacting battery cells;
providing an electronic component according to claim 1;
first connecting the electrical connecting elements to the printed circuit board by soldering; and
subsequently connecting the electrical connecting elements to the cell connectors.

14. A method for producing a battery module, which comprises the steps of:
providing a battery having battery cells;
providing an electronic component according to claim 1;
providing a cell-contacting system having a plurality of cell connectors which serve for power contacting the battery cells;
first connecting the cell-contacting system to the battery without the electronic component; and
subsequently electrically connecting the printed circuit board to the cell connectors by means of the connecting elements.
